(19) United States
(12) Patent Application Publication
(10) Pub. No.: US 2014/0124434 A1
(43) Pub. Date: May 8, 2014

(54) FILTER

(71) Applicant: Samsung Electro-Mechanics Co., Ltd., Suwon (KR)

(72) Inventors: Jae-Joon Lee, Suwon (KR); Kyo-Young Son, Suwon (KR); Choon-Keun Lee, Suwon (KR); Joung-Gul Ryu, Suwon (KR)

(73) Assignee: Samsung Electro-Mechanics Co., Ltd., Suwon (KR)

(21) Appl. No.: 14/045,371

(22) Filed: Oct. 3, 2013

(30) Foreign Application Priority Data
Nov. 2, 2012 (KR) 10-2012-0123807

(51) Int. Cl. B01D 29/00

(52) U.S. Cl. CPC B01D 29/0004
USPC 210/435

(57) ABSTRACT

A filter is disclosed. The filter in accordance with an embodiment of the present invention is installed in a conduit through which resin mixed with filler passes, and includes a plate having an area corresponding to a horizontal section of the conduit and having a plurality of openings formed therein for filtering the filler. Each of the plurality of openings includes a first opening area and the second opening area that intersect with each other and are each elongated in one direction and have a predetermined width for filtering the filler.

### CROSS-REFERENCE TO RELATED APPLICATIONS

This application claims the benefit of Korean Patent Application No. 10-2012-0123807, filed with the Korean Intellectual Property Office on Nov. 2, 2012, the disclosure of which is incorporated herein by reference in its entirety.

### BACKGROUND

1. Technical Field

The present invention relates to a filter.

2. Background Art

Today's high performance, smaller electronic devices increasingly require thinner package boards with an improved speed of signal transmission. The printed circuit boards for satisfying this market demand need to have little or no warpage during the fabrication or packaging process.

The main cause of warpage in a printed circuit board is an incongruity of the coefficient of thermal expansion (CTE) between materials in a crystallized structure. In order to reduce the incongruity of CTE, build-up materials other than copper need to have small CTEs, for which a number of studies are actively in progress.

In reality, a mixed system of resin and filler is often used for the build-up materials, and the property of the (mixed) build-up materials is realized through controlling the amount or characteristics of the filler among the mixed materials.

The build-up materials are made to a product through a mixing process, in which the resin and the filler are mixed, and a dispersion and coating process. Since the size of the filler prior to the coating process affects the quality of the product, a filtering process is also introduced to filter out sphere-shaped filler.

Used for the filtering process is a bag filter with a predetermined size or a cartridge-type filter for better filtering. The bag filter has a net structure interlaced with warp and weft. Accordingly, this net structure of filter takes a long time to filter the viscous resin mixed with the sphere-shaped filler due to the high load applied to the filter.

The related art of the present invention is disclosed in Korea Patent Publication No. 2012-0070980 (METAL FILTER HAVING MULTI-LAYERED STRUCTURE AND FILTERING METHOD THEREOF; laid open on Jul. 2, 2012).

### SUMMARY

The present invention provides a filter that can reduce a filtering load and maintain a filtering precision through a change in woven structure.

The filter in accordance with an embodiment of the present invention is installed in a conduit through which resin mixed with filler passes, and includes a plate having an area corresponding to a horizontal section of the conduit and having a plurality of openings formed therein for filtering the filler. Each of the plurality of openings includes a first opening area and the second opening area that intersect with each other and are each elongated in one direction and have a predetermined width for filtering the filler.

An area where the first opening area and the second opening area intersect with each other can have a width that is substantially the same as the predetermined width for filtering the filler.

A distance between two points where the first opening area and the second opening area intersect with each other can be substantially the same as the predetermined width for filtering the filler.

Each of the first opening area and the second opening area can have an end portion thereof formed in a curved shape.

The first opening area and the second opening area can intersect orthogonally with each other.

### BRIEF DESCRIPTION OF THE DRAWINGS

FIG. 1 shows how a filter is installed in accordance with an embodiment of the present invention.

FIG. 2 is a top view showing a filter in accordance with an embodiment of the present invention.

FIG. 3 is a top view showing the structure of an opening of the filter in accordance with an embodiment of the present invention.

FIG. 4 is a top view showing the structure of an opening of a filter in accordance with another embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain technology is determined to evade the point of the present invention, the pertinent detailed description will be omitted.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

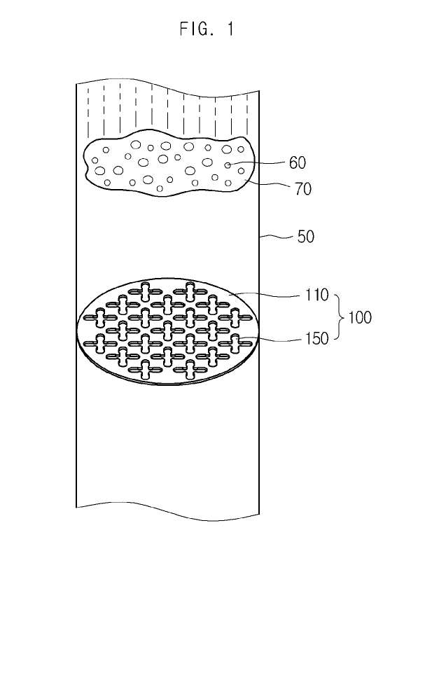

Hereinafter, a filter in accordance with some embodiments of the present invention will be described with reference to FIG. 1 to FIG. 4.

FIG. 1 shows how a filter is installed in accordance with an embodiment of the present invention.

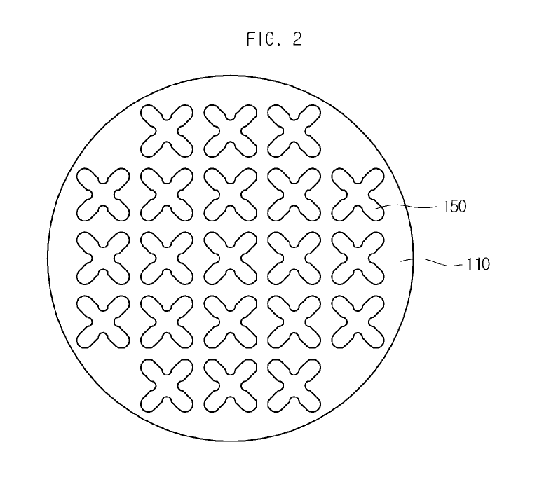

FIG. 2 is a top view showing a filter in accordance with an embodiment of the present invention.

Referring to FIGS. 1 and 2, a filter 100 in accordance with an embodiment of the present invention is installed in a conduit 50 through which a resin 70 mixed with a sphere-shaped filler 60 passes.

Specifically, the filter 100 includes a plate 110 and a plurality of openings 150.

The plate 110 has an area corresponding to a horizontal section of the conduit 50. Moreover, the plate 110 includes the plurality of openings 150, through which the filler 60 and the resin 70 pass. For this, the plate 110 is formed with a predetermined thickness for the openings 150 to be formed therein.

The plurality of openings 150 are formed in the plate 110 in such a way that the filler 60 and the resin 70 can pass through the openings 150. Each of the plurality of openings 150 performs a function of filtering the filler 60 exceeding a predetermined diameter to reduce or remove an incongruity of coefficient of thermal expansion. Each of the plurality of openings 150 is formed with a structure for efficiently filtering the sphere-shaped filler 60 with a desired size.

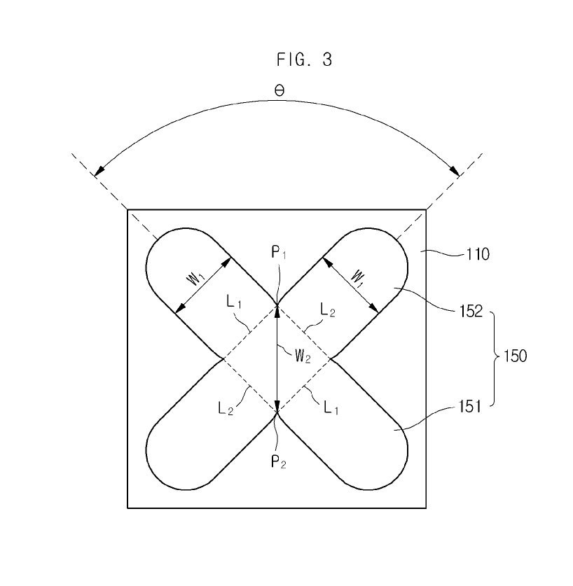

Hereinafter, the openings 150 of the filter 100 in accordance with an embodiment of the present invention will be described in detail with further reference to FIG. 3.

FIG. 3 is a top view showing the structure of an opening of the filter in accordance with an embodiment of the present invention.

Referring further to FIG. 3, the opening 150 includes a first opening area 151 and a second opening area 152 that intersect with each other. Here, the first opening area 151 and the second opening area 152 are each formed in a long-hole shape that is elongated in each respective direction. Moreover, the first opening area 151 and the second opening area 152 are each formed with a first width W₁ that is predetermined for filtering the filler 60. Here, the first width W₁ of each of the first opening area 151 and the second opening area 152 corresponds to a diameter of the filler 60 that is predetermined to reduce or remove the incongruity of coefficient of thermal expansion. Moreover, the first opening area 151 and the second opening area 152 are formed to be orthogonal to each other. In other words, an angle θ between the first opening area 151 and the second opening area 152 is 90°.

Here, the first opening area 151 and the second opening area 152 are formed in such a way that a second width W₂ at an area where the first opening area 151 and the second opening area 152 intersect with each other is substantially the same as the first width W₁. Specifically, a first intersecting point P₁ and a second intersecting point P₂ of the first opening area 151 and the second opening area 152 are separated by the second width W₂, which is substantially the same as the first width W₁. Here, the second width W₂ is a distance between the first intersecting point P₁ and the second intersecting point P₂. Moreover, the second width W₂ is a diagonal length of a square formed with a first virtual line L₁ and a second virtual line L₂ that are each shorter than the first width W₁.

As illustrated in FIG. 3, the first opening area 151 and the second opening area 152 can be each formed in a shape that the first intersecting point P₁ and the second intersecting point P₂ are sharply bent toward each other in such a way that the second width W₂ is substantially the same as the first width W₁. The first opening area 151 and the second opening area 152 having the first intersecting point P₁ and the second intersecting point P₂ sharply bent toward each other can filter the filler 60 exceeding the predetermined diameter at an area where the first opening area 151 and the second opening area 152 intersect with each other.

Moreover, the first opening area 151 and the second opening area 152 can each have an end portion thereof formed in a curved shape in order to prevent stress from being concentrated.

In the above-described opening 150, the first opening area 151 and the second opening area 152, through which the filler 60 passes, are each formed to have the width that is smaller than a predetermined width, thereby making it possible to maintain a filtering precision. Moreover, it is possible to shorten the time required for filtering by making the opening areas, through which the filler 60 and the resin 70 can pass, larger than a mesh of a net-type structure. Through this, the opening 150 can reduce a filtering load.

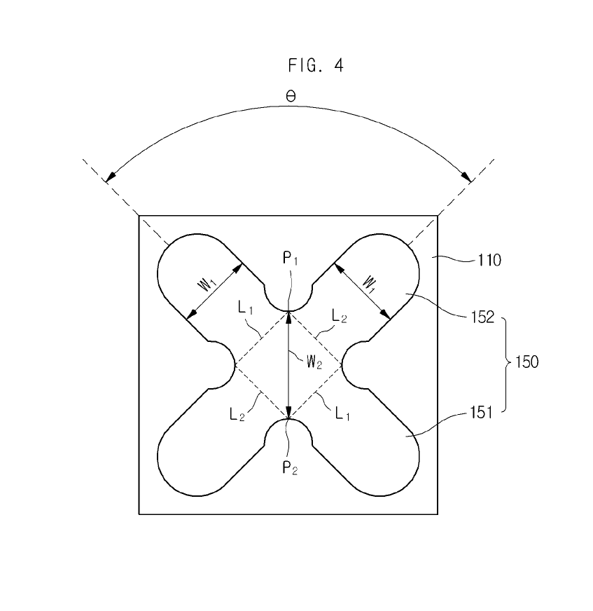

FIG. 4 is a top view showing the structure of an opening of a filter in accordance with another embodiment of the present invention. Here, any identical elements to those of FIG. 3 will be briefly described.

Referring to FIG. 4, an opening 150 includes a first opening area 151 and a second opening area 152 that intersect with each other.

The first opening area 151 and the second opening area 152 are each formed in a long-hole shape that is elongated in each respective direction. Moreover, the first opening area 151 and the second opening area 152 are each formed with a first width W₁ that is predetermined for filtering the filler 60. Moreover, the first opening area 151 and the second opening area 152 are formed to be orthogonal to each other. In other words, an angle θ between the first opening area 151 and the second opening area 152 is 90°.

Here, the first opening area 151 and the second opening area 152 are each formed in such a way that a second width W₂, which is a distance between a first intersecting point P₁ and a second intersecting point P₂ at which the first opening area 151 and the second opening area 152 intersect with each other, is substantially the same as a first width W₁. Here, the second width W₂ is a diagonal length of a square formed by a first virtual line L₁ and a second virtual line L₂ that are each shorter than the first width W₁. For this, the first opening area 151 and the second opening area 152 can be each formed in a shape that the first intersecting point P₁ and the second intersecting point P₂ are curved toward each other.

Moreover, the first opening area 151 and the second opening area 152 can each have an end portion thereof formed in a curved shape in order to prevent stress from being concentrated.

In the filter in accordance with an embodiment of the present invention, the opening areas are formed with a predetermined width, thereby making it possible to maintain the filtering precision. Moreover, by making the opening areas of the opening larger than the mesh of the net-type structure, the filtering load can be reduced, and the filtering time can be shortened.

Although a certain embodiment of the present invention has been described, it shall be appreciated that there can be a very large number of permutations and modification of the present invention by those who are ordinarily skilled in the art to which the present invention pertains without departing from the technical ideas and boundaries of the present invention, which shall be defined by the claims appended below.

It shall be also appreciated that many other embodiments other than the embodiment described above are included in the claims of the present invention.

What is claimed is:

1. A filter installed in a conduit through which resin mixed with filler passes, the filter comprising a plate having an area corresponding to a horizontal section of the conduit and having a plurality of openings formed therein, the plurality of openings being configured for filtering the filler,
wherein each of the plurality of openings comprises a first opening area and the second opening area, the first opening area and the second opening area intersecting with each other, each of the first opening area and the second opening area being elongated in one direction and having a predetermined width for filtering the filler.

2. The filter of claim 1, wherein an area where the first opening area and the second opening area intersect with each other has a width that is substantially the same as the predetermined width for filtering the filler.

3. The filter of claim 1, wherein a distance between two points where the first opening area and the second opening area intersect with each other is substantially the same as the predetermined width for filtering the filler.

4. The filter of claim 1, wherein each of the first opening area and the second opening area has an end portion thereof formed in a curved shape.

5. The filter of claim 1, wherein the first opening area and the second opening area intersect orthogonally with each other.
